(19) United States
(12) Patent Application Publication
(10) Pub. No.: US 2008/0215395 A1
(43) Pub. Date: Sep. 4, 2008

(54) METHOD AND SYSTEM FOR GOTV EFFORTS

(76) Inventors: Ravneet SINGH, Naperville, IL (US); Simerneet SINGH, Chicago, IL (US)

Correspondence Address: CARDINAL LAW GROUP, Suite 2000, 1603 Orrington Avenue, Evanston, IL, 60201, US

(21) Appl. No.: 12/041,448

(22) Filed: Mar. 3, 2008

Related U.S. Application Data
(60) Provisional application No. 60/892,380, filed on Mar. 1, 2007.

(51) Int. Cl. G06Q 10/00; G06Q 20/00; G06F 17/30

(52) U.S. Cl. 705/7; 705/12; 705/44

(57) ABSTRACT

A method for controlling campaign management includes receiving a login request from a user at a central location and receiving a campaign management request from the user responsive to the login request. The method further includes selecting at least a first campaign from a plurality of campaigns based on the campaign management request, associating the selected first campaign with the user based on the selection, recording the association within at least a first database, and compiling a plurality of analytic data based on the recorded association. Additionally, the method includes providing at least a second campaign to the user based on the compiled analytic data.

### RELATED APPLICATIONS

This application claims the benefit of, and priority to, U.S. Provisional Patent Application 60/892,380, filed Mar. 1, 2007, and incorporates the entirety of that application by reference herein.

### FIELD OF THE INVENTION

The present invention relates to Internet-based non-partisan solutions for elections and campaigns. The present invention generally relates to access to and maintenance of various enrolled Internet services and purchased Internet tools for elections and campaigns, particular supporter donations.

### BACKGROUND OF THE INVENTION

ElectionMall™ Technologies, Inc (hereinafter “Election Mall”) is continually striving to be the world leader in providing Internet-based non-partisan solutions for elections and campaigns that effectively utilizes technology and business know-how to enable candidates, organizations and other elected representatives to generate enhanced gains in awareness, funds and votes. To this end, the winning solutions provided by Election Mall encompass fundraising for soliciting and managing election and campaign finances, web services for managing elections and campaigns, tools for managing election and campaign content, Get-Out-The-Vote (“GOTV”) for sending election and campaign messages in an efficient manner, and shopping for providing access to election and campaign products (e.g., eyardsigns). A challenge therefore for Election Mall is to continually strive to improve upon and add to website applications for providing its winning solutions.

### SUMMARY OF THE INVENTION

The present invention provides a new and unique website application for campaigns and elections.

### BRIEF DESCRIPTION OF THE DRAWINGS

The benefits and advantages of the present invention will become more readily apparent to those of ordinary skill in the relevant art after reviewing the following detailed description and accompanying drawings, wherein:

FIGS. 1-5 illustrate methods of operating a campaign, in accordance with multiple aspects of the invention;

FIG. 6 illustrates a virtual yard sign process flow in accordance with one aspect of the invention; and

FIG. 7 illustrates a data collection flow in accordance with another aspect of the invention.

### DETAILED DESCRIPTION OF THE INVENTION

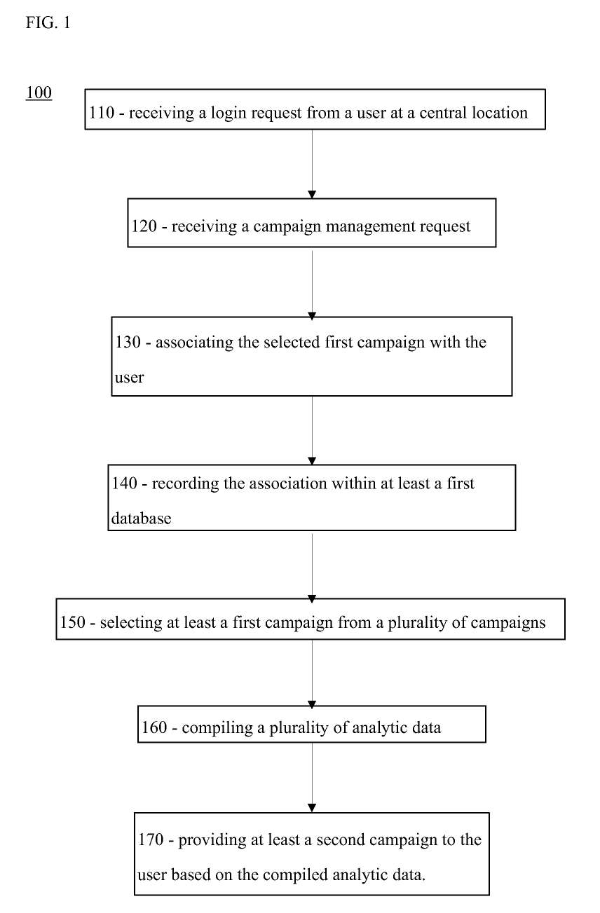

FIG. 1 illustrates a flowchart of a method 100 for controlling campaign management, in accordance with one aspect of the invention. Method 100 includes receiving, at step 110, a login request from a user at a central location. In one embodiment, the central location is a web site offered by a server or a collection of server in communication with the user via a network, such as the Internet. The central location receives, at step 120, a campaign management request from the user responsive to the login request. In one embodiment, the user must satisfy a security challenge, such as a password or the like.

At step 130, at least a first campaign is selected from a plurality of campaigns based on the campaign management request. In one embodiment, the campaign is associated with at least one candidate for at least one political office. The selected first campaign is associated with the user based on the selection at step 140. The association can comprise creation of metadata associating the first campaign and user. At step 150, the association is recorded within at least a first database, and a plurality of analytic data is compiled based on the recorded association at step 160. Based on the compiled analytic data, the central location provides, at step 160, at least a second campaign to the user based on the compiled analytic data. The second campaign may be associated with a different campaign in certain examples. Alternatively, the second campaign be associated with either an issue or party associated with the first campaign. For example, if the first campaign relates to a democratic candidate for president, the second campaign can relate to a democratic candidate for the senate, or relate to an issue upon which the candidate associated with the first campaign has taken a stand. Even further, if the first campaign is associated with candidate “A” for mayor, the second campaign may be associated with candidate “A” for Mayor and with candidate B for alderman.

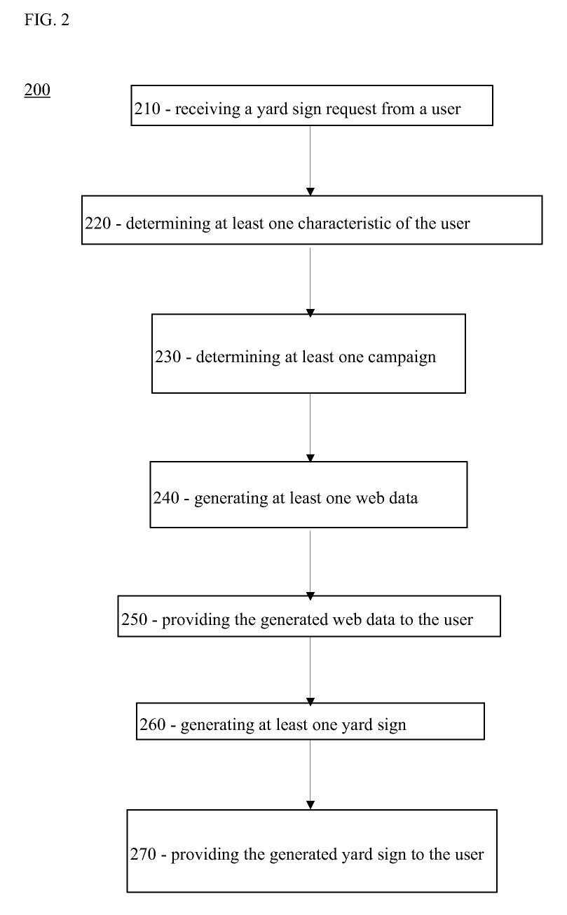

FIG. 2 illustrates a flowchart illustrating a method 200 for controlling campaign management, in accordance with one aspect of the invention. Method 200 begins at 210 by receiving a yard sign request from a user. The yard sign is a paper or other material of sufficient rigidity to support ink in at least a partially indelible manner. In one embodiment, the yard sign is a poster, while in other embodiments, the yard sign can be a flyer, or include at least one post for insertion into the ground for display of the yard sign. The post may include plastic, wood, or metal. Based on receiving the request, at step 220, at least one characteristic of the user is determined. The characteristic of the user can be any appropriate characteristic or other identifying data, such as name, address, political affiliations, political views, admired candidates, unadmired candidates, issues of particular importance to the user, voting information such as precinct and/or prior voting history, volunteer information relating to prior volunteer efforts made by the user on behalf of campaigns, donation information associated with prior monetary or in kind donations made the user, and the like. In other embodiments, at least some of the characteristics can be determined by consulting public and/or private databases based on at least one characteristic provided by the user. For example, upon receipt of the user's name, a database including monetary and/or in kind donations can be accessed, and this information obtained and associated with the user, with and/or without knowledge of the user.

At step 230, method 200 determines at least one campaign based on the determined characteristic, and generates, at step 240, at least one web data based on the determined campaign. In one embodiment, the web data includes at least one ‘widget’ and/or lines of computer code for transference to at least one social networking site to associate at least one profile of the user with the determined campaign. At step 250, the generated web data is provided to the user based on the yard sign request. In one embodiment, the web data is provided in the form of text, while in other embodiments, the web data is provided in the form of files or both files and text. In another embodiment, the web data is sent directly to the social networking site with, in some embodiments, or without, in other embodiments, authorization from the user.

At step 260, at least one yard sign is generated based on the determined campaign, and at step 270, method 200 provides the generated yard sign to the user based on the yard sign request. In one embodiment, the yard sign is printed at a venue near the user, while in other embodiments, the yard sign is printed distant from the user and mailed to the user. In other embodiments, the yard sign is printed by the user.

In one embodiment, at least one other social network site user is determined based on the web data and the user is provided the determined other social network user. In one embodiment, the other social network user is provided the user identity as well. Such embodiments can assist in forming grass roots campaign efforts.

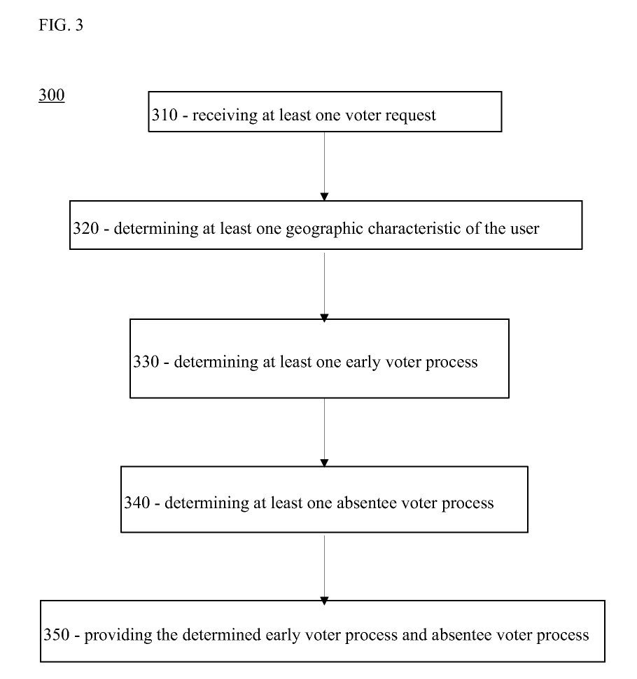

FIG. 3 illustrates a flowchart illustrating a method 300 of campaign management, in accordance with one aspect of the invention. Method 300 includes receiving at least one voter request from a user at step 310, and determining at least one geographic characteristic of the user based on the received request at step 320. In one embodiment, the geographic characteristic includes at least one political subdivision associated with the user, such as state, city, and or precinct for voting. Method 300 continues at step 330 by determining at least one early voter process based on the determined geographic characteristic based on the determined geographic characteristic. An early voter process is any method by which the user may be allowed to, but is not required to, cast their vote prior to an official date of voting. In each political subdivision, there may or may not be any early voting process. At step 340, method 300 determines at least one absentee voter process based on the determined geographic characteristic based on the determined geographic characteristic. An absentee voter process is any method by which the user may be allowed to vote without a physical appearance at a polling site and/or allowed to vote prior to the official date of voting. In each political subdivision there may or may not be an absentee voter process. Additionally, both early voter processes and absentee voter processes are known to vary from political subdivision to political subdivision. In one embodiment, at least one of the early voter processes and absentee voter processes is determined by accessing at least one public and/or private database based on the determined geographic characteristic. Having determined the early voter processes and absentee voter processes, the user is provided, to the extent such exists the determined early voter process and absentee voter process to the user based on the determinations, at step 350. In one embodiment, the user is informed if at least one of the early voter processes and absentee voter processes does not apply within their political subdivision. In one embodiment, if at least one of the early voter processes and absentee voter processes is unavailable to the user, the user is provided contact information for at least one elected official and/or voting commissioner to request institution of the same.

In one embodiment, at least one campaign identifier is received from the user. In various embodiments, either with and/or without permission from the user, the identity of the user and/or their contact information is provided, with the determined early voter process and absentee voter process to at least one campaign, based on the campaign identifier. In such as fashion, the campaign may assist the user in ensuring that their early and/or absentee ballot is cast in accordance with the user's wishes. Alternatively, the campaign can offer assistance in accessing the voting place on the official voting day, if appropriate. Alternatively, if numerous requests are received, the campaign may include the same in campaigning, based on compiled analytics.

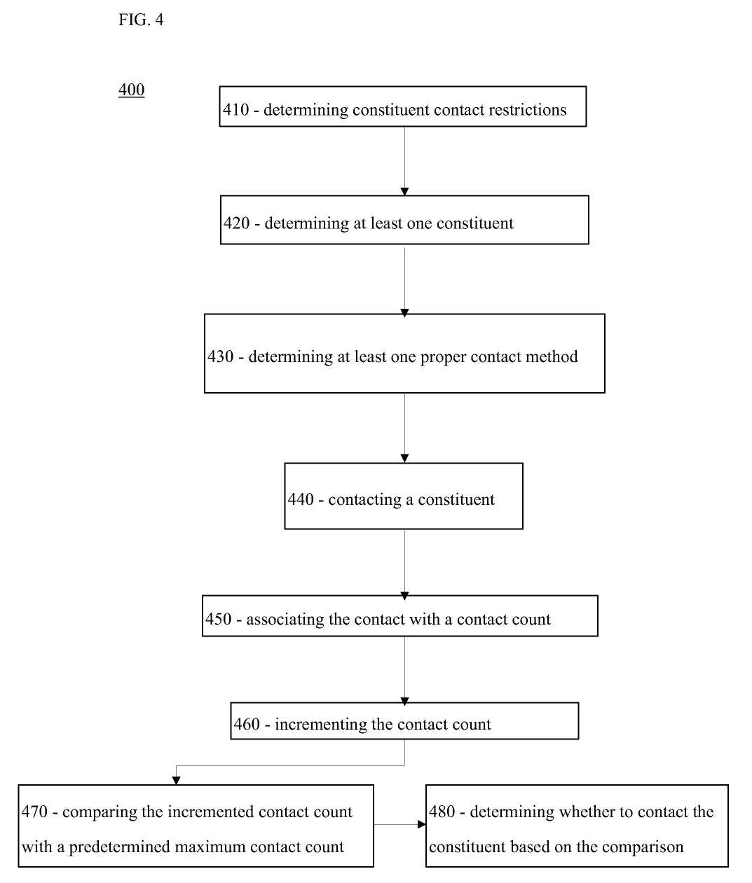

FIG. 4 illustrates one example of a flowchart illustrating a method 400 for campaign management, in accordance with one aspect of the invention. Method 400 begins at step 410 by determining constituent contact restrictions associated with a plurality of geographic areas. Certain geographic areas restrict methods of contact with their residents, such as by precluding phone calls, or precluding phone calls over a certain number of calls within a time span. Alternatively, it is know that residents of different geographic areas feel differently about various methods, and/or frequency of contact such that residents of one area are not offended by 10 calls, whereas residents of other areas are believed to be offended by 3 calls, or the like. At step 420, method 400 determines at least one constituent of the geographic areas, and at step 430 by determining at least one proper contact method based on the determined constituent contact restrictions and determined constituent. At step 440, the constituent is contacted using at least one contact method, and at step 450, the contact is associated with contact count based on the contact. A contact count associated with each contacted constituent is maintained, such as by using a database. At step 460, the contact count is incremented based on the contact. At step 470, the incremented contact count is compared with a predetermined maximum contact count. Based on the comparison, at step 480, method 400 determines whether to contact the constituent another time. In one embodiment, at least a first analytic is determined based on the contact, and the determined analytic is provided to a campaign.

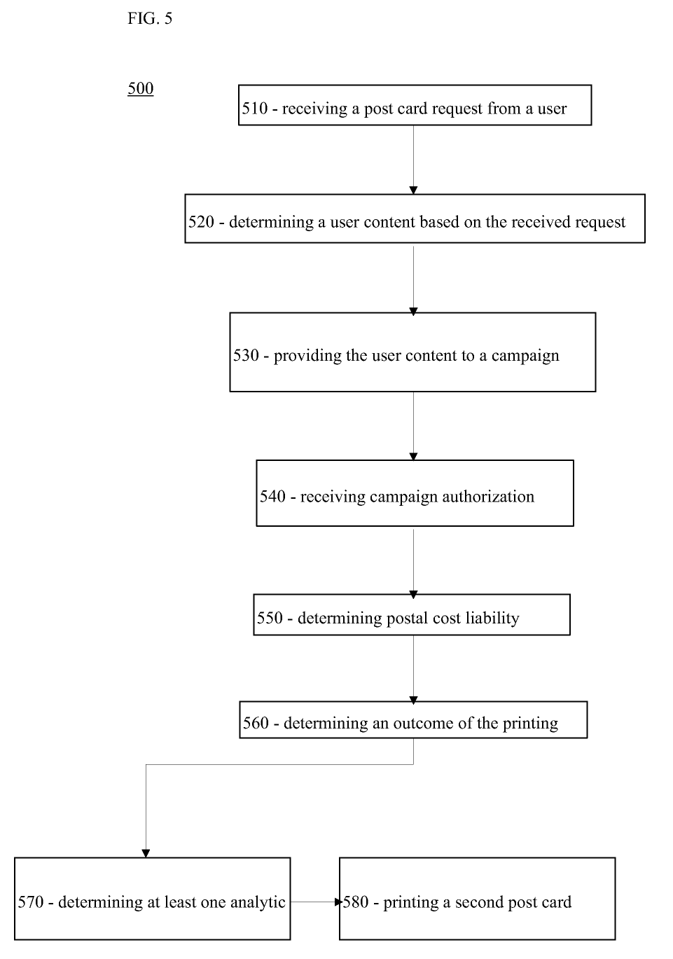

FIG. 5 illustrates one example of a flowchart illustrating a method 500 for managing a campaign, in accordance with one aspect of the invention. Method 500 begins at step 510 by receiving a post card request from a user. Additionally, a user content is determined based on the received request at step 520. The user content is at least one string of alphanumeric characters that the user desires to transmit via a paper mail system to a third person. In one embodiment, the user content is associated with at least one campaign. The received user content is provided to a campaign at step 530, and at step 540, method 500 continues by receiving campaign authorization based on the provided user content. In one example, the campaign only authorizes the user content when the user content is accurate or relates to the campaign, or casts the campaign in a positive light, or conveys a message desired by the campaign. In one embodiment, the user can select from a series of ‘user content’ suggested by campaigns prior to entry.

Having determined authorization, method 500 determines postal cost liability, at step 550, based on the provided user content. The postal cost liability relates to the monetary cost of mailing a postcard containing the user content. Based on the postal cost liability, method 500 prints, at step 560, at least a first post card based on the campaign authorization and determined postal cost liability. At step 570, method 500 determines an outcome of the printing. The outcome can be the receipt of contact by the campaign by the recipient, or receipt of donations or the like. At step 580, method 500 determining at least one analytic based on the determined outcome and prints a second post card based on the user content and determined analytic such that the second post card different from the first post card. In such a way, the campaign can determine the effectiveness of multiple communications, including communications that did not originate with campaign staff (but have been approved by the same) and learn from these communications to maximize future benefits.

In one embodiment, method 500 further includes determining a post card cost. The post card cost is associated with the cost of printing and sending the post card. Additionally, in one embodiment, method 500 further includes receiving payment of the liability based on the determination, and providing a portion of the received payment to a user. In such an embodiment, the user is allowed to share in monetary rewards that accumulate to a campaign for preparation of effective copy. In other embodiments, the method includes determining a post card cost, receiving payment of the liability based on the determination, and providing a portion of the received payment to a campaign.

The methods and techniques disclosed herein includes ways for voters and constituents to donate, volunteer, register to vote, absentee ballot, spread the word via email or print card (postal mail), raise money on behalf of the campaigns. These are common political participation behaviors. But they are difficult to do because of a lack of resources and techniques.

A single location offering each of the methods described herein, allows you to do this by allowing them to get information based on their profile information. It does this by pulling up the right information for voter registration, polling location, absentee ballot and even candidates that are in their area; so they can donate, volunteer and participate in their campaigns. As more and more people participate, the database calculates and records the necessary actions taken to continue to monitor campaigns participation levels. The more in the area will help the candidate have a greater chance of winning their election. The system will allow them to send more and more invitation via the web. However, this is based on the criteria of their voter profile. This information will share what is the strength of each of these participation levels for the campaigns. Suggesting the right emails and responses based on their campaign activities, the activities of similar campaign profiles, and that of other users behavior. In fact, the database can be shared or not shared to help likeminded candidates benefit from each other's efforts during a campaign season, or those of past campaigns. This way campaigns can gather intelligence of data based on previous user behavior. The system then suggests the best method to turn out the vote. This can be done by email, video, print car, and audio. eYardsign is also integrated with social networking sites, universal browsers and various applications. It can also generate these things on the fly and can be fully customizable by the user.

This yard sign generator allows you to share your campaign message in electronic format. The problem is that distribution of literature and information about a campaign is common. It is known that larger distribution of a campaign message correlates with a favorable outcome. Campaigns wish to “control” a message. While allowing their facts, figures to be shared, the yard sign and other methods herein disclosed gives the user the ability to search candidates based on issues, office, party affiliation, geographic region, election date, type of election (primary, general) and then generate a marketing url, rss, script, and image that they can send to encourage others to participate in the campaign, while the data will also go to the campaign for their benefit. If this is (a) “non-control” message users are able to generate their own content by also opening a “voter or user” account that will spiral and they can use for their own advocacy. This information is not shared with the campaign but is utilized for analytic behavior for future campaigns.

The ability for you to make a pledge to a campaign without actually making a contribution, while the image resides on your site based upon your participation on that page. It will identify your location and display information of candidate profile of those that reside in your area only, based on profile, cookie, IP address, and other information. Your donation would be able to go to a fund of the cause, candidate, or a general fund based on party affiliation. This donor information will help with other likeminded solicitors.

Based on the user profile, the information selects the most likely form of registration and runs it across a database to see if they are registered. If they are not it prompts them and pre-fills the information on the form. The remaining information is requested by email, phone, fax, direct mail. The system however, is able to determine based on behavior whether or not they are registered or not from the central database. It prompts and reminds them with the compliance every step of the way to fill in the remaining information. All while sharing this information with the campaign and helping them in this process. The ability to identify voters and non-voters that are registered is key to the application because they will help with victory for the campaign

People are not available to participate in the campaign on election day. The system identifies these individuals ahead of times and schedules ways for them to provide the information to election commissions, campaigns, and also helps get others to schedule their absentee ballot. The system also takes pre-registration information because some states do not allow you to get this information ahead of time. Also, it shares with common like behavior based on economic, social class, and identifies those who would be most likely not to be able to participate.

The system also rewards them with the ability to recruit others, actually complete the process, and informs them of their outcome, specified to their geographic participation of the absentee ballot.

While early voting is becoming more common, often this information is not readily available. The system will identify or display information on the eYardsign for those along with a countdown based on the user's IP address and email, and self generate account or actions taken in other fields. This will prompt them to cast their ballot online and share it with the campaign so they know how many votes they have before walking into election day. This is a vote gathering system that syncs with GPS, the address of the participant and other participation data that is collected as well.

The problem is that this information can help target messaging to help change the outcome. Tailoring a message by a volunteer profile is one way. However, this application takes it a step further by identifying others who have likeminded coalitions and allows you to volunteer for campaigns that are similar in one click. Rather than filling out multiple forms. This is the current behavior. The system will trigger and email, phone, SMS to the campaign, but at the same time allowing them to get information in one central location. And based on their profile determine their participation and where it is most affective for the campaign. This information is not usually shared with the voter. But selected information like profile information, ethnicity, occupation, interest, and religion can help maximize the participation.

The most common of the ability to send material to a friend is by email. However, a behavior in campaigns is that of send to friend post cards. This involves control messaging. This is done by a web interface where the card can be shared with others, content can be shared, and address and profile information is being collected. However, besides receiving the information the user will receive a unique ID that will allow them to access special information about the campaign on hand and more importantly to contribute to content. Therefore, the campaign DOES not have to generate content for each send 2 friend postcard. The voters help shape the message of the campaigns. This feature can be turned on or off depending on the control. The designs can be uploaded by the administrator or can be submitted by the users. For example at a fundraiser, you have taken a photo and then this could be shared. Voters would then pay to send this out on behalf of the campaign. The information is collected in a compliance format for fundraising laws that pull from the disclaimers, eligibility, and restrictions on the amount of money that can be actually given.

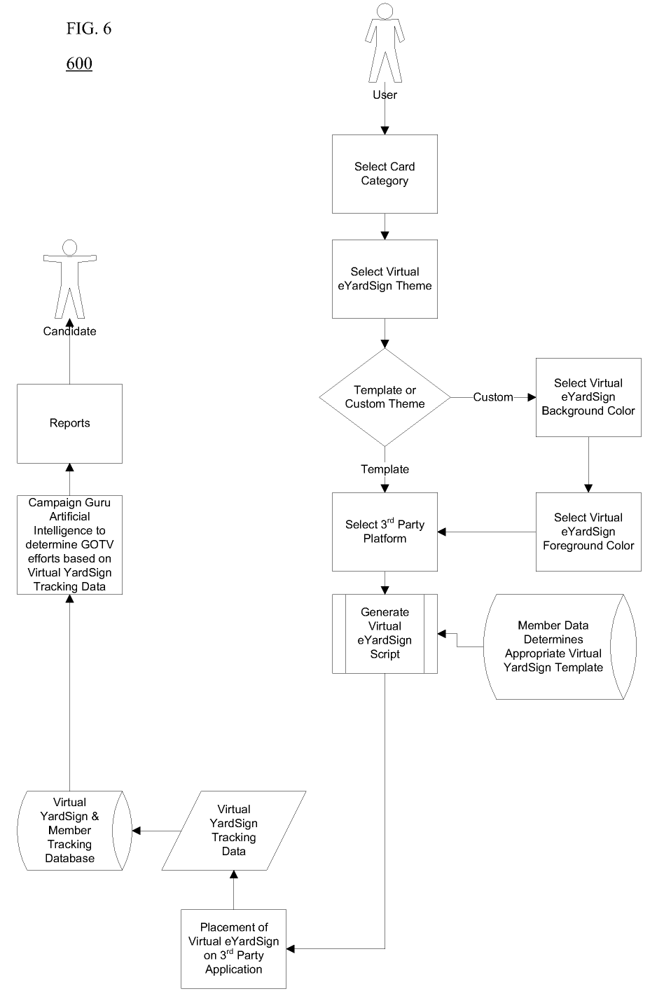

FIG. 6 illustrates a virtual yard sign process flow in accordance with one aspect of the invention.

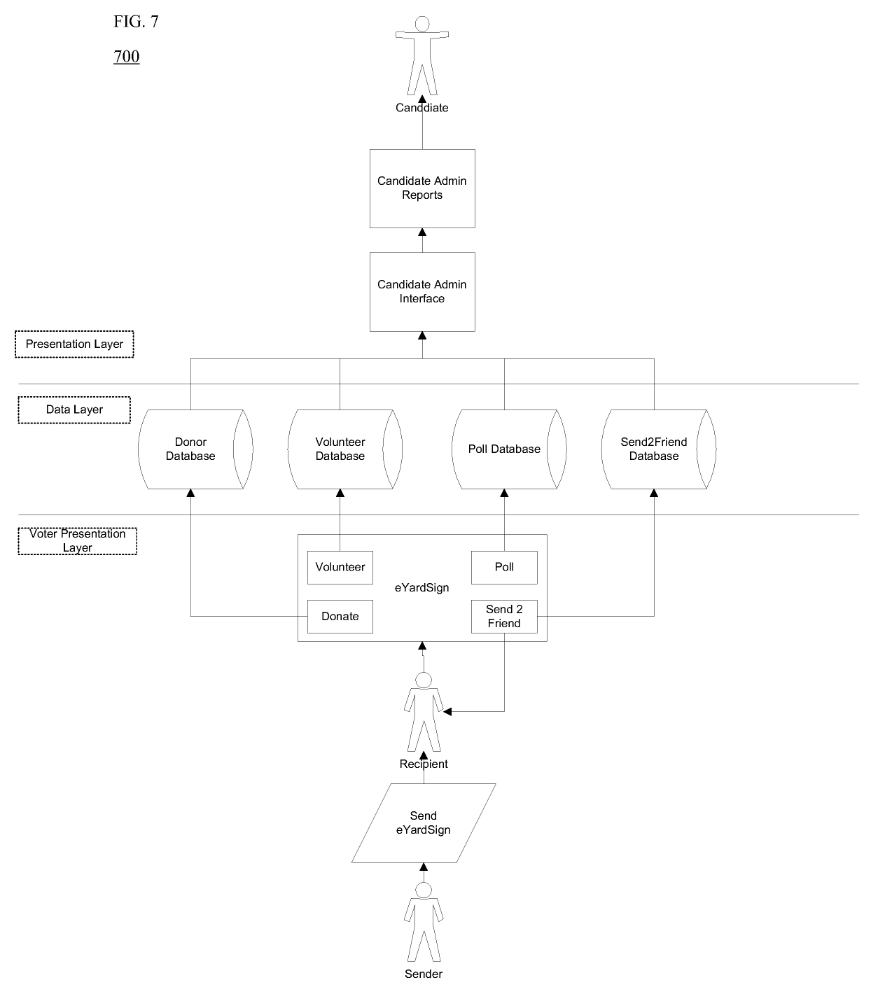

FIG. 7 illustrates a data collection flow in accordance with another aspect of the invention.

While specific embodiments of the invention are disclosed herein, various changes and modifications can be made without departing from the spirit and scope of the invention.

What is claimed is:

1. A method for controlling campaign management, the method comprising:
receiving a login request from a user at a central location;
receiving a campaign management request from the user responsive to the login request;
selecting at least a first campaign from a plurality of campaigns based on the campaign management request;
associating the selected first campaign with the user based on the selection;
recording the association within at least a first database;
compiling a plurality of analytic data based on the recorded association;
providing at least a second campaign to the user based on the compiled analytic data.

2. A method for controlling campaign management;
receiving a yard sign request from a user;
determining at least one characteristic of the user;
determining at least one campaign based on the determined characteristic;
generating at least one web data based on the determined campaign;
providing the generated web data to the user based on the yard sign request;
generating at least one yard sign based on the determined campaign;
providing the generated yard sign to the user based on the yard sign request.

3. The method of claim 3 wherein the web data is associated with at least one social networking site.

4. The method of claim 4 further comprising determining at least one other social network site user based on the web data and providing the user the determined other social network user.

5. A method of campaign management comprising:
receiving at least one voter request from a user;
determining at least one geographic characteristic of the user based on the received request;
determining at least one early voter process based on the determined geographic characteristic based on the determined geographic characteristic;
determining at least one absentee voter process based on the determined geographic characteristic based on the determined geographic characteristic;
providing the determined early voter process and absentee voter process to the user based on the determinations.

6. The method of claim 5 further comprising:
receiving at least one campaign identifier from the user; and
providing the determined early voter process and absentee voter process to at least one campaign based on the campaign identifier.

7. A method of campaign management comprising:
determining constituent contact restrictions associated with a plurality of geographic areas;
determining at least one constituent of the geographic areas;
determining at least one proper contact method based on the determined constituent contact restrictions and determined constituent;
contacting a constituent using at least one contact method;
associating the contact with a contact count based on the contact;
incrementing the contact count based on the contact;
comparing the incremented contact count with a predetermined maximum contact count;
determining whether to contact the constituent based on the comparison.

8. The method of claim 7 further comprising:
determining at least a first analytic based on the contact;
providing the determined analytic to a campaign.

9. A method of managing a campaign, the method comprising:
receiving a post card request from a user;
determining a user content based on the received request;
providing the user content to a campaign;
receiving campaign authorization based on the provided user content;
determining postal cost liability based on the provided user content;
printing a first post card based on the campaign authorization and determined postal cost liability;
determining an outcome of the printing;
determining at least one analytic based on the determined outcome;
printing a second post card based on the user content and determined analytic, the second post card different from the first post card.

10. The method of claim 9, further comprising:
determining a post card cost,
receiving payment of the liability based on the determination;
providing a portion of the received payment to a user.

11. The method of claim 9, further comprising:
determining a post card cost,
receiving payment of the liability based on the determination;
providing a portion of the received payment to a campaign.
